(19) United States
(12) Patent Application Publication
(10) Pub. No.: US 2025/0127246 A1
(43) Pub. Date: Apr. 24, 2025

(54) IOT-BASED COLD VEST

(71) Applicant: JANG EUN FNC CO., LTD, Seoul (KR)

(72) Inventor: Eun Jeong JANG, Seoul (KR)

(21) Appl. No.: 18/537,259

(22) Filed: Dec. 12, 2023

(30) Foreign Application Priority Data
Oct. 23, 2023 (KR) 10-2023-0142417

(51) Int. Cl. A41D 13/005; A41D 1/04; G16Y 20/10

(52) U.S. Cl. CPC A41D 13/0053; A41D 1/04; F25B 2321/021; G16Y 20/10

(57) ABSTRACT

The present disclosure relates to an IoT-based cooling vest including a clothing part 100, a controller 200, a temperature collector 300, a user terminal 400, and a server unit to improve work safety and wearing pleasantness for a wearer by enabling temperature to be adjusted through both direct operation and previous operation through a server.

### CROSS REFERENCE TO RELATED APPLICATION

The present application claims priority to Korean Patent Application No. 10-2023-0142417, filed on Oct. 23, 2023, the entire contents of which are incorporated herein for all purposes by this reference.

### BACKGROUND

### Technical Field

An embodiment of the present disclosure relates to an IoT-based cold vest.

### Description of the Related Art

Recently, devices that are coupled to clothing to make it possible to adjust temperature in accordance with the body temperature of users or external environments are releasing. However, there are few products that fundamentally satisfy convenience for activity of users, a convenient wearable feature, and convenience for washing.

In particular, since cooling temperature is set only on the basis of the body temperature of users, there is a lack of preparatory measures or post measures according to weather.

Accordingly, it is required to develop a technology for efficiently using energy, securing activity convenience and convenient wearable feature for users, and effectively keeping and transmitting coolness.

### SUMMARY

An objective of an embodiment of the present disclosure is to provide an IoT-based cold vest that has a cooling unit and can effectively transmit coolness to a wearer using circulation of cooled fluid.

Another objective is to provide an IoT-based cold vest that enables temperature adjustment through both temperature adjustment by a wearer and use of weather information.

The technical subject to implement in the present disclosure is not limited to the technical problems described above and other technical subjects that are not stated herein will be clearly understood by those skilled in the art from the following specifications.

An IoT-based cold vest related to an embodiment of the present disclosure for achieving the objectives described above, first, may include a clothing part configured to form one or more cooling areas with cold holders in which a plurality of flexible unit cooling modules is inserted.

Further, the IoT-based cold vest may include a controller detachably disposed on the clothing part, supplying electrical energy to the unit cooling modules, and having a communication module to control the unit cooling modules by transmitting first temperature adjustment information to the unit cooling modules.

In this configuration, the IoT-based cold vest may include a temperature collector configured to collect cooling temperature information that is transmitted to the unit cooling modules.

In this configuration, the IoT-based cold vest may include a user terminal connected to the communication module through a network and configured to collect the cooling temperature information and transmit second temperature adjustment information to the controller to control the unit cooling modules.

Further, the IoT-based cold vest may include a server connected to the user terminal through a network and configured to collect the cooling temperature information and the first temperature adjustment information and transmit third temperature adjustment information to the user terminal so that the unit cooling modules are controlled.

In this configuration, a cooling channel may be formed in the unit cooling modules, cold air generated by a Peltier element may flow through the cooling channels, and a plurality of unit cooling modules may be configured to form one cooling area.

In this configuration, the server may collect the cooling temperature information of an individual wearer from the user terminal, may be configured such that wearing position information, position information of a plurality cooling portions, and portion-specific cooling information are collected as the collected cooling temperature information and cooling states of respective parts of a human body are collected, and may be configured to transmit the third temperature adjustment information to the user terminal on the basis of weather information, which includes temperature, humidity, and wind information at an area where a wearer is positioned that are collected from an external weather system, and the cooling temperature information.

Further, the unit cooling module may be configured such that inflow tubes guiding cold air generated by the Peltier element into the cooling channel are detachably connected to the cooling channel.

In this configuration, the cooling channel may be formed by bending one tube and may be repeatedly bent in S shapes from a side to the other side in a longitudinal going direction, whereby a line of unit cooling passages may be formed and the unit cooling passages may be continuously formed with predetermined intervals from a side to the other side in a width direction to provide a cooling area unit.

Meanwhile, the unit cooling module may be configured such that a first surface is formed toward the skin of a wearer under the cooling channel, a second surface is disposed opposite to the first surface, the temperature collector is disposed at the position of the first surface at the position of an outlet hole of the cooling channel, a plurality of cylindrical cooling protrusions is formed on the first surface, and many cooling gap spaces that are perpendicular between a wearer and the first surface are formed between the cooling protrusions.

In this configuration, a cold air inflow tube and a cold air outflow tube of a unit cooling module adjacent to any one unit cooling module may be detachably connected to each other, whereby the cooling area may be formed by the unit cooling modules; and the air inflow tube and the cold air outflow tube may be made of a flexible material so that the cooling area corresponds to a curve of a human body.

Meanwhile, a UV coating layer may be disposed on the surface of the clothing part and fine heat discharge holes may be irregularly configured at the cold holder to discharge heat that is discharged from a Peltier thermoelectric element, a human body, or the unit cooling modules.

In this configuration, a user input unit and a temperature display unit may be disposed at the controller such that when a user operates the user input unit, the first temperature adjustment information is created as input information and the unit cooling modules are controlled.

Further, the user terminal may be configured such that the cooling temperature information is shown in an installed application, and the second temperature adjustment information may be formed as information that is input into the user input unit by a user touching a screen.

Further, the server may have a model trained to extract features and the possibility of a danger of skin temperature on the basis of a temperature difference between center temperature of the front and the back of the body of a wearer and portions around the front and the back for learning data as an artificial intelligence model from which thermal pleasantness information of a human body is extracted on the basis of feature analysis of the portion-specific cooling information.

Accordingly, the present disclosure provides an IoT-based cold vest, so it is possible to adjust temperature through both direct operation by a wearer and previous operation through a server using cooling temperature information of the wearer and weather information around the wearer, thereby providing an effect increasing work safety and wearing pleasantness.

Further, there is an effect of increasing activity convenience for the wearer using the cooling members made of a flexible material that is convenient and light, and increasing convenience for washing through a detachable structure.

Meanwhile, the effects of the present disclosure are not limited to the effects described above and other effects can be clearly understood by those skilled in the art from the following description.

### BRIEF DESCRIPTION OF THE DRAWINGS

The above and other objectives, features and other advantages of the present invention will be more clearly understood from the following detailed description when taken in conjunction with the accompanying drawings, in which:

FIG. 1 is a view showing the entire configuration of an IoT-based cold vest according to a preferred embodiment of the present disclosure;

FIGS. 2 and 3 are views showing a unit cooling module of the IoT-based cold vest according to a preferred embodiment of the present disclosure;

FIGS. 4 and 5 are views showing a cooling channel of the IoT-based cold vest according to a preferred embodiment of the present disclosure;

FIGS. 6 and 7 are views showing a first surface of the IoT-based cold vest according to a preferred embodiment of the present disclosure;

FIG. 8 is a view showing a cold air inflow tube and a cold air outflow tube of the IoT-based cold vest according to a preferred embodiment of the present disclosure;

FIGS. 9 and 10 are views showing a UV coating layer and heat discharge holes of the IoT-based cold vest according to a preferred embodiment of the present disclosure; and

FIG. 11 is a view showing a controller, a temperature collector, a user terminal, and a server unit for the IoT-based cold vest according to a preferred embodiment of the present disclosure.

### DETAILED DESCRIPTION

Specific structural and functional description about embodiments according to the concept of the present disclosure disclosed herein is exemplified only to describe the embodiments according to the concept of the present disclosure and the embodiments according to the concept of the present disclosure may be implemented in various ways and are not limited to the embodiments described herein.

Hereinafter, the term “unit” is defined herein as having its broadest definition to ordinary skill in the art. The term “unit” may refer to software including instructions executable in a non-transitory computer-readable medium that would perform the associated function when executed, a circuit or a processor designed to perform the associated function, hardware designed to perform the associated function, or a combination of them.

Embodiments described herein may be changed in various ways and various shapes, so specific embodiments are shown in the drawings and will be described in detail in this specification. However, it should be understood that the exemplary embodiments according to the concept of the present disclosure are not limited to the specific examples, but all of modifications, equivalents, and substitutions are included in the scope and spirit of the present disclosure.

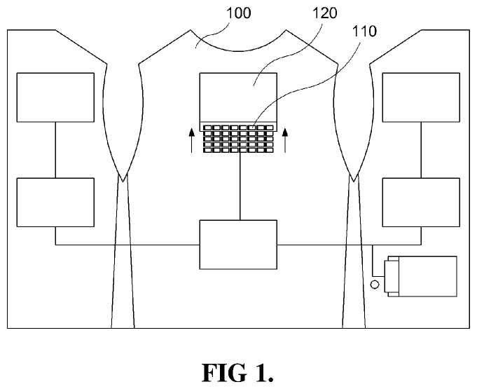

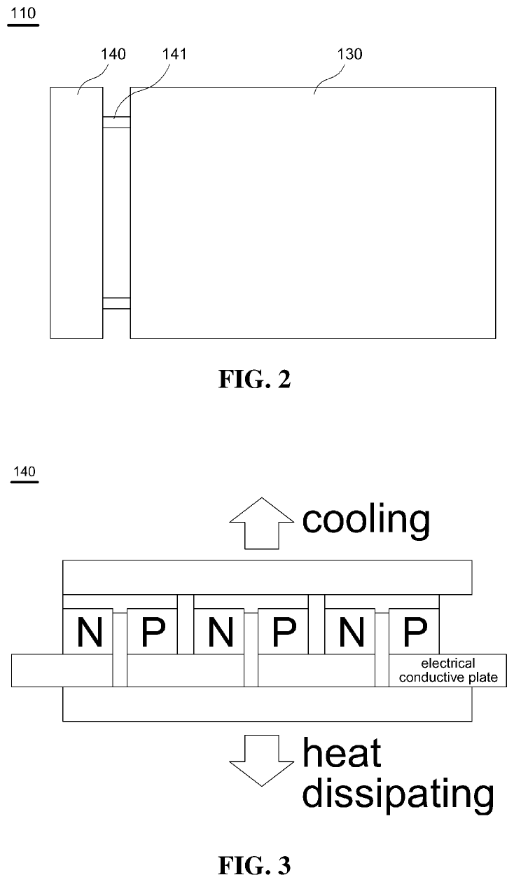

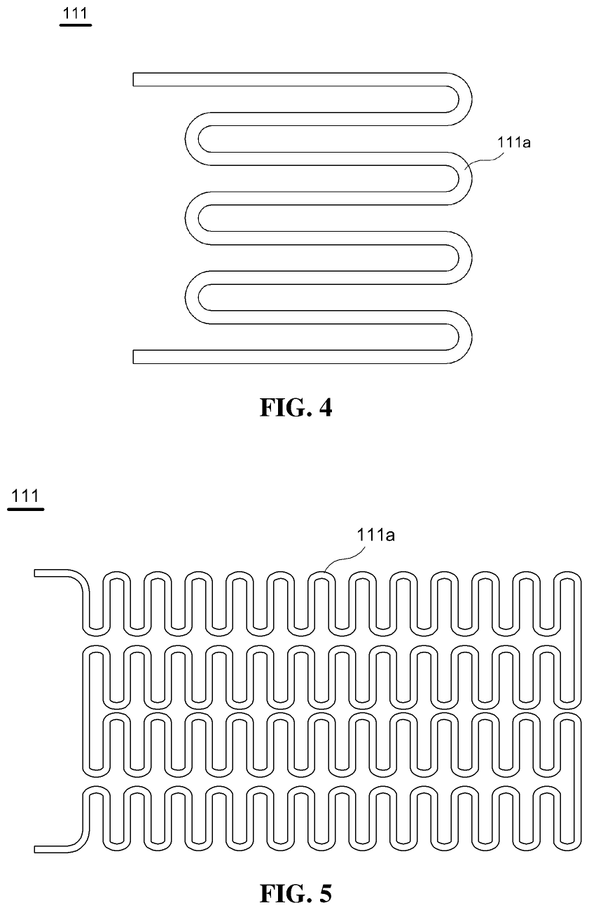

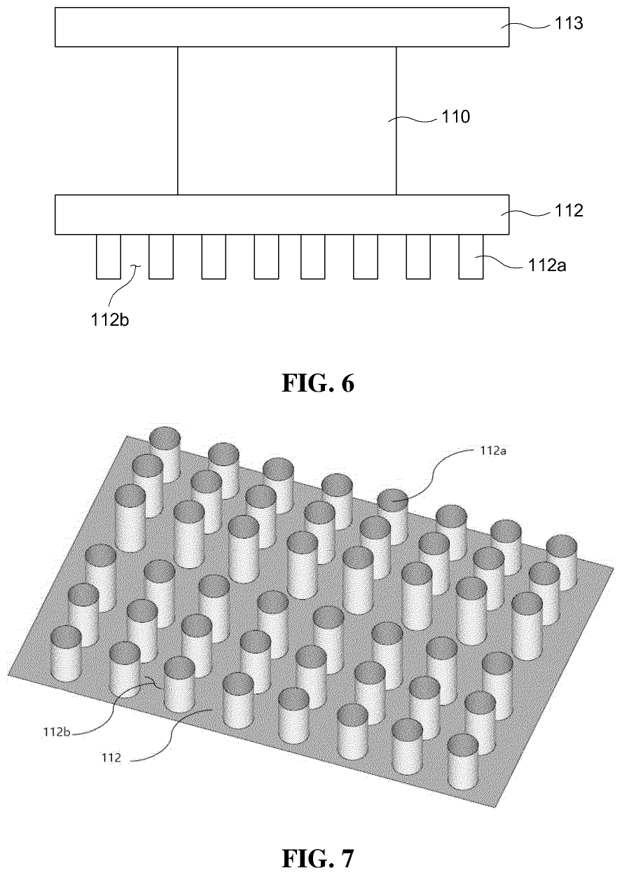

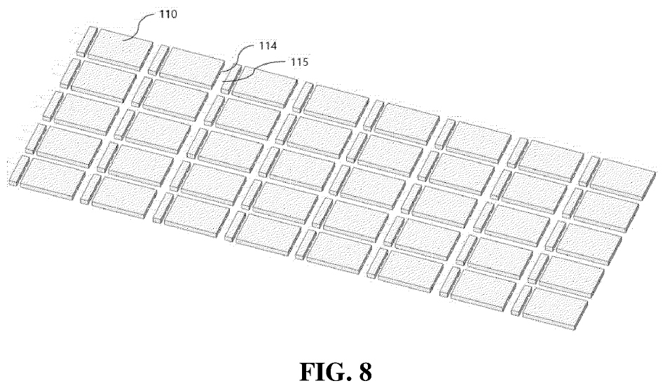

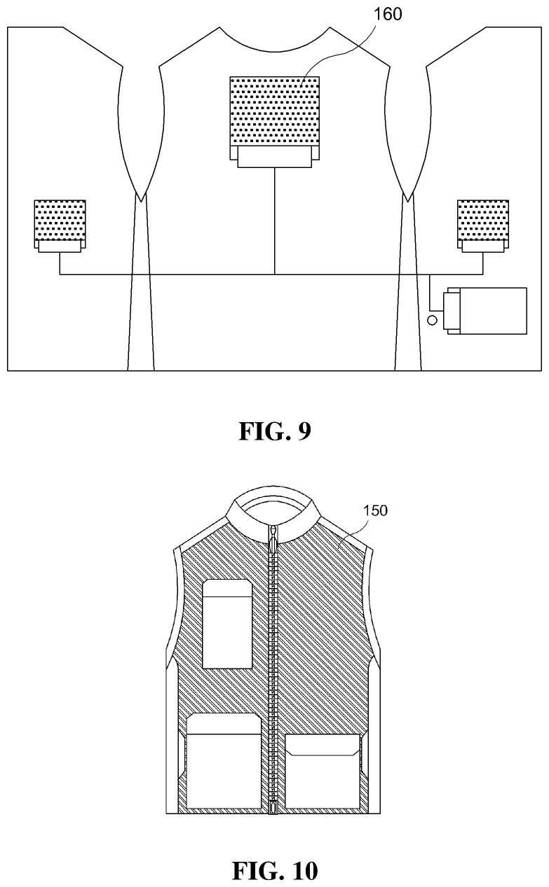

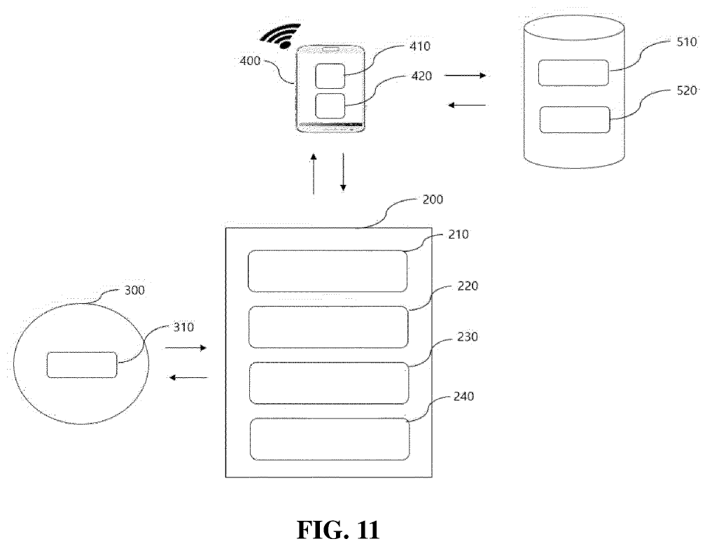

FIG. 1 is a view showing the entire configuration of an IoT-based cold vest according to a preferred embodiment of the present disclosure, FIGS. 2 and 3 are views showing a unit cooling module of the IoT-based cold vest according to a preferred embodiment of the present disclosure, FIGS. 4 and 5 are views showing a cooling channel of the IoT-based cold vest according to a preferred embodiment of the present disclosure, FIGS. 6 and 7 are views showing a first surface of the IoT-based cold vest according to a preferred embodiment of the present disclosure, FIG. 8 is a view showing a cold air inflow tube and a cold air outflow tube of the IoT-based cold vest according to a preferred embodiment of the present disclosure, FIGS. 9 and 10 are views showing a UV coating layer and heat discharge holes of the IoT-based cold vest according to a preferred embodiment of the present disclosure, and FIG. 11 is a view showing a controller, a temperature collector, a user terminal, and a server unit of the IoT-based cold vest according to a preferred embodiment of the present disclosure.

In an IoT-based cold vest related to an embodiment of the present disclosure, first, a clothing part 100 forming one or more cooling areas 130 with cold holders 120 in which a plurality of flexible unit cooling modules 110 is inserted is configured.

Further, a controller 200 that is detachably disposed on the clothing part 100, supplies electrical energy to the unit cooling modules 110, and has a communication module 220 to control the unit cooling modules 110 by transmitting first temperature adjustment information 210 to the unit cooling modules 110 is configured.

In this configuration, the unit cooling modules 110 and the controller 200 are configured to be attachable/detachable to/from the clothing part 100 so that the clothing part 100 can be washed.

In this configuration, a temperature collector 300 that is also detachably disposed on the clothing part 100, measures cooling temperature information 310, which is the body temperature of a wearer, and transmits the cooling temperature information 310 to the controller 200 is configured.

In this configuration, the temperature collector 300 may be integrally configured with the controller 200, and when several temperature collectors 300 are disposed for one controller 200, the temperature collectors are connected through wired connectors.

Further, a user terminal 400 that is connected to the communication module 220 through a network, collects the cooling temperature information 310, and transmits second temperature adjustment information 410 to the controller 200 to control the unit cooling modules 110 is configured. It is preferable that the user terminal 400 is a smartphone that a user can easily carry.

Further, a server unit 500 that is connected to the user terminal 400 through a network, collects and stores the cooling temperature information 310 and the first temperature adjustment information 210 in a database, and transmits third temperature adjustment information 510 to the user terminal 400 so that the unit cooling modules 110 are controlled is configured.

That is, the server unit 500 is configured to be able to transmit control information enabling the unit cooling modules 110 to be cooled by communicating with the controller 200 using the user terminal 400.

Further, a cooling channel 111 is formed in the unit cooling modules 110, cold air generated by a Peltier element 140 flows through the cooling channels 111, and a plurality of unit cooling modules 110 is configured to form one cooling area 130.

Meanwhile, the server unit 500 collects the cooling temperature information 310 of an individual wearer from the user terminal 400, is provided such that wearing position information 311, position information 312 of a plurality cooling portions, and portion-specific cooling information 313 are collected as the collected cooling temperature information 310 and the cooling states of respective parts of a human body are collected, and is configured to transmit the third temperature adjustment information 510 to the user terminal 400 on the basis of weather information 520, which includes the temperature, humidity, and wind information at the area where a wearer is positioned that are collected from an external weather system, and the cooling temperature information 310.

Further, the unit cooling module 110 is configured such that inflow tubes 141 guiding cold air generated by the Peltier element 140 into the cooling channel 111 are detachably connected to the cooling channel 111.

In this configuration, the cooling channel 111 is, as shown in FIGS. 4 and 5, formed by bending one tube and is repeatedly bent in S shapes from a side to the other side in the longitudinal going direction, whereby a line of unit cooling passages 111a is formed. Further, a plurality of unit cooling passages 111a is continuously formed with predetermined intervals from a side to the other side in a width direction to provide a cooling area unit.

In this configuration, the unit cooling passages 111a may be disposed in a direction parallel with a first direction, as shown in FIG. 4, or may be disposed in a direction parallel with a second direction, as shown in FIG. 5. In this configuration, the first direction is a direction parallel with the inflow tube 141 and the second direction is a direction perpendicular to the first direction.

Meanwhile, the unit cooling module 110 is configured such that a first surface 112 is formed toward the skin of a wearer under the cooling channel 11, a second surface 113 is disposed opposite to the first surface 112, the temperature collector 300 is disposed at the position of the first surface 112 at the position of an outlet hole of the cooling channel 111, a plurality of cylindrical cooling protrusions 112a is formed on the first surface 112, and many cooling gap spaces 112b that are perpendicular between a wearer and the first surface 112 are formed between the cooling protrusions 112a to form a gap from a skin or clothing.

In this configuration, the cold air inflow tube 114 and the cold air outflow tube 115 of a unit cooling module 110 adjacent to any one unit cooling module 110 are detachably connected to each other, whereby the cooling area 130 is formed by a plurality of unit cooling modules 110. The cold air inflow tube 114 and the cold air outflow tube 115 are made of a flexible material so that the cooling area 130 corresponds to a curve of a human body. A UV coating layer 150 is disposed on the surface of the clothing part 100 and fine heat discharge holes 160 are irregularly configured at the cold holder 120 to discharge heat that is discharged from a Peltier thermoelectric element 140, a human body, or the unit cooling modules 110.

In this configuration, a user input unit 230 and a temperature display unit 240 are disposed at the controller 200 such that when a user operates the user input unit 230, the first temperature adjustment information 210 is created as input information and the unit cooling modules 110 are controlled.

Further, the user terminal 400 is provided such that the cooling temperature information 310 is shown in an installed application 420 and is configured such that the second temperature adjustment information 410 is calculated as information that is input into the user input unit 230 by a user touching a screen.

The second temperature adjustment information 410 is calculated by the application 420 in consideration of temperature of collected cooling information, a variation rate of cooling information, and currently remaining electrical energy.

Further, the server unit 500 has a model trained to extract features and the possibility of a danger of skin temperature on the basis of the temperature difference between the center temperature of the front and the back of the body of a wearer and the portions around the front and back for learning data as an artificial intelligence model from which thermal pleasantness information of a human body is extracted on the basis of feature analysis of the portion-specific cooling information 313 to be able to transmit the third temperature adjustment information 510 suitable for a wearer.

Using the IoT-based cold vest of the present disclosure described above makes it possible to adjust temperature through both direct operation by a wearer and previous operation through a server using cooling temperature information of the wearer and weather information around the wearer, thereby being able to provide an effect of increasing work safety and wearing pleasantness, increase activity convenience for the wearer using the cooling members made of a flexible material that is convenient and light, and provide an effect of increasing convenience for washing through a detachable structure.

Preferred embodiments of the present disclosure were described above, but it would be understood by those skilled in the art that these embodiments described above are only examples of the spirit of the present disclosure and the present disclosure may be changed in various ways without departing from the spirit of the present disclosure. Accordingly, the protective range of the present disclosure should be construed by those described in claims rather than specific embodiments and all spirits within a corresponding range should also be construed as being included in the right range of the present disclosure.

What is claimed is:

1. An IoT-based cold vest comprising:
a clothing part configured to form one or more cooling areas with cold holders in which a plurality of flexible unit cooling modules is inserted;
a controller detachably disposed on the clothing part, supplying electrical energy to the unit cooling modules, and having a communication module to control the unit cooling modules by transmitting first temperature adjustment information to the unit cooling modules;
a temperature collector configured to collect cooling temperature information that is transmitted to the unit cooling modules;
a user terminal connected to the communication module through a network and configured to collect the cooling temperature information and transmit second temperature adjustment information to the controller to control the unit cooling modules; and
a server unit connected to the user terminal through a network and configured to collect the cooling temperature information and the first temperature adjustment information and transmit third temperature adjustment information to the user terminal so that the unit cooling modules are controlled.

2. The IoT-based cold vest of claim 1, wherein a cooling channel is formed in the unit cooling modules, cold air generated by a Peltier element flows through the cooling channels, and a plurality of unit cooling modules is configured to form one cooling area.

3. The IoT-based cold vest of claim 2, wherein the unit cooling module is configured such that inflow tubes guiding cold air generated by the Peltier element into the cooling channel are detachably connected to the cooling channel; and
the cooling channel is formed by bending one tube and is repeatedly bent in S shapes from a side to the other side in a longitudinal going direction, whereby a line of unit cooling passages is formed and the unit cooling passages are continuously formed with predetermined intervals from a side to the other side in a width direction to provide a cooling area unit.

4. The IoT-based cold vest of claim 3, wherein the unit cooling module is configured such that a first surface is formed toward the skin of a wearer under the cooling channel, a second surface is disposed opposite to the first surface, the temperature collector is disposed at the position of the first surface at the position of an outlet hole of the cooling channel, a plurality of cylindrical cooling protrusions is formed on the first surface, and many cooling gap spaces that are perpendicular between a wearer and the first surface are formed between the cooling protrusions.

5. The IoT-based cold vest of claim 4, wherein a cold air inflow tube and a cold air outflow tube of a unit cooling module adjacent to any one unit cooling module are detachably connected to each other, whereby the cooling area is formed by the unit cooling modules; and
the air inflow tube and the cold air outflow tube are made of a flexible material so that the cooling area corresponds to a curve of a human body.

6. The IoT-based cold vest of claim 5, wherein a UV coating layer is disposed on the surface of the clothing part and fine heat discharge holes are irregularly configured at the cold holder to discharge heat that is discharged from a Peltier thermoelectric element, a human body, or the unit cooling modules.

7. The IoT-based cold vest of claim 6, wherein a user input unit and a temperature display unit are disposed at the controller such that when a user operates the user input unit, the first temperature adjustment information is created as input information and the unit cooling modules are controlled.

8. The IoT-based cold vest of claim 7, wherein the user terminal is configured such that the cooling temperature information is shown in an installed application, and the second temperature adjustment information is formed as information that is input into the user input unit by a user touching a screen and cooling temperature of the unit cooling modules is controlled.

9. The IoT-based cold vest of claim 8, wherein the server unit collects the cooling temperature information of an individual wearer from the user terminal, is configured such that wearing position information, position information of a plurality cooling portions, and portion-specific cooling information are collected as the collected cooling temperature information and cooling states of respective parts of a human body are collected, and is configured to transmit the third temperature adjustment information to the user terminal on the basis of weather information, which includes temperature, humidity, and wind information at an area where a wearer is positioned that are collected from an external weather system, and the cooling temperature information; and
the server unit has a model trained to extract features and the possibility of a danger of skin temperature on the basis of a temperature difference between center temperature of the front and the back of the body of a wearer and portions around the front and the back for learning data as an artificial intelligence model from which thermal pleasantness information of a human body is extracted on the basis of feature analysis of the portion-specific cooling information.
